(19) United States
(12) Patent Application Publication
(10) Pub. No.: US 2015/0261139 A1
(43) Pub. Date: Sep. 17, 2015

(54) INTERMEDIATE TRANSFERER AND IMAGE FORMING APPARATUS

(71) Applicants: Hidetaka Kubo, Kanagawa (JP); Jun Aoto, Kanagawa (JP); Atsufumi Hanazawa, Tokyo (JP)

(72) Inventors: Hidetaka Kubo, Kanagawa (JP); Jun Aoto, Kanagawa (JP); Atsufumi Hanazawa, Tokyo (JP)

(73) Assignee: RICOH COMPANY, LTD., Tokyo (JP)

(21) Appl. No.: 14/635,356

(22) Filed: Mar. 2, 2015

(30) Foreign Application Priority Data
Mar. 14, 2014 (JP) 2014-051253

(51) Int. Cl. G03G 15/01

(52) U.S. Cl. CPC G03G 15/162; G03G 15/0131

(57) ABSTRACT

An intermediate transferer a toner image formed by developing a latent image on an image bearer with a toner is transferred onto includes a substrate including a polycarbonate resin and a carbon black. The intermediate transferer has a surface resistivity of from 10 to 12 Log Ω/□ when applied with a volt of 500 V, a volume resistivity of from 7.5 to 9.5 Log Ω·cm when applied with a volt of 100 V, and a difference between the surface resistivity and the volume resistivity of from 1.5 to 4.0 digits.

### CROSS-REFERENCE TO RELATED APPLICATIONS

This patent application is based on and claims priority pursuant to 35 U.S.C. §119 to Japanese Patent Application No. 2014-051253, filed on Mar. 14, 2014, in the Japan Patent Office, the entire disclosure of which is hereby incorporated by reference herein.

### BACKGROUND

1. Technical Field

The present invention relates to an intermediate transferer equipped in image forming apparatuses such as copiers and printers, and to an image forming apparatus using the same.

2. Description of the Related Art

In the conventional art, a belt, especially a seamless belt, has been used for various purpose, as a member in an electrophotographic image forming apparatus. In recent years, an intermediate transfer belt system has been used in a full-color image forming apparatus, where the intermediate transfer belt system includes superimposing developed images of four colors, yellow, magenta, cyan, and black temporarily on an intermediate transfer member, and collectively transferring the superimposed images onto a transfer medium, such as paper.

As for the aforementioned intermediate transfer belt, a system using developing units of four respective colors to one photoconductor has been used, but this system has a problem that a printing speed thereof is slow. Accordingly, to achieve high speed printing, a quarto-tandem system has been used, where the tandem system includes providing photoconductors of four respective colors, and an image of each color is continuously transferred to paper. In this system, however, it is very difficult to accurately position images of colors to be superimposed, as the paper is affected by the fluctuations of the environment, which causing color shift in the image. Accordingly, currently, an intermediate transfer belt system has been mainly adapted for the quarto-tandem system.

Under the circumstances as mentioned above, the higher requirements for properties (high speed transferring, and accuracy for positioning) of a intermediate transfer belt have been demanded than before, and therefore it is necessary for an intermediate transfer belt to satisfy these requirements. Especially for the accuracy for positioning, it has been required to inhibit variations caused by deformation of an intermediate transfer belt itself, such as stretching, after continuous use thereof. Moreover, an intermediate transfer belt is desired to have flame resistance as it is provided over a wide region of a device, and high voltage is applied thereto for transferring. To satisfy these demands, a polyimide resin or a polyamideimide resin that is a highly elastic and highly heat resistant resin, has been mainly used as a material of an intermediate transfer belt.

However, since an intermediate transfer belt formed of a polyimide resin has high strength and high surface hardness, it applies high pressure to a toner layer when transferring a toner image, resulting in occasional hollow images because a toner unevenly aggregates and a part of an image is not transferred. In addition, the intermediate transfer belt has low followability with a contact member such as a photoconductor and a paper, resulting in occasional void images because of partial defective contact (gap). Further, polyimide and polyamide imide resins are very expensive.

When a toner image is transferred onto a transfer material from an outer circumferential surface of an intermediate transfer belt at a second transfer nip, a spot discharge occasionally occurs in the second transfer nip, resulting in a white spot on a toner image transferred on the transfer material. Particularly when a transfer material has high resistance due to low humidity environment and backside copy, a higher bias applied to form a second transfer electric filed tends to cause spot discharge in the second transfer nip, resulting in a white spot.

In order to solve these problems, the following methods are disclosed.

Japanese published unexamined application No. JP-2009-258699-A discloses a method of forming two or more polyimide layers, and further increasing resistivity of the outermost surface.

However, two or more coating liquids are needed, and further the polyimide resin needs heating at 400° C., which costs much.

Japanese published unexamined application No. JP-2013-33250-A discloses a method of using carbon black as a polycarbonate base resin to form an intermediate transfer belt by wet coating, and further specifying an elasticity thereof.

However, this relates to releasability from a mold and the resistivity is not studied in detail although carbon black is used to make the belt conductive. A relation between the surface resistivity and the volume resistivity, and dependency of the volume resistivity on a voltage are not referred. Therefore, abnormal images such as white spots may be produced.

Japanese Patent No. JP-4406782-B2 (Japanese published unexamined application No. JP-2001-47451-A) discloses specifying a relation between pH and volatile component of carbon black, and surface resistivity and volume resistivity to form a high-quality and high-performance polyimide film.

Japanese published unexamined application No. JP-2010-122437-A discloses specifying the surface resistivity and the volume resistivity of a polyimide belt including a conductive filler to prevent uneven reverse transfer at low humidity.

However, these relate to a polyimide resin, and the hollow images and the void images are produced.

### SUMMARY

Accordingly, one object of the present invention is to provide a low-cost intermediate transferer having good transferability without causing abnormal images such as white spot.

Another object of the present invention is to provide an image forming apparatus using the intermediate transferer.

These objects and other objects of the present invention, either individually or collectively, have been satisfied by the discovery of an intermediate transferer a toner image formed by developing a latent image on an image bearer with a toner is transferred onto, including a substrate including a polycarbonate resin; and carbon black wherein the intermediate transferer has a surface resistivity of from 10 to 12 Log Ω/□ when applied with a volt of 500 V, a volume resistivity of from 7.5 to 9.5 Log Ω·cm when applied with a volt of 100 V, and a difference between the surface resistivity and the volume resistivity of from 1.5 to 4.0 digits.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention; and

FIG. 2 is a schematic view illustrating another embodiment of the image forming apparatus of the present invention.

### DETAILED DESCRIPTION

The present invention provides a low-cost intermediate transferer having good transferability without causing abnormal images such as white spot.

More particularly, the present invention provides an intermediate transferer a toner image formed by developing a latent image on an image bearer with a toner is transferred onto, including a substrate including a polycarbonate resin; and carbon black wherein the intermediate transferer has a surface resistivity of from 10 to 12 Log Ω/□ when applied with a volt of 500 V, a volume resistivity of from 7.5 to 9.5 Log Ω·cm when applied with a volt of 100 V, and a difference between the surface resistivity and the volume resistivity of from 1.5 to 4.0 digits.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

In the electrophotographic image forming apparatuses, seamless belts are used for some members. A seamless intermediate transfer belt is one of important members, satisfying high electrical properties. Hereinafter, the intermediate transferer of the present invention is explained. The shape thereof is not limited to that of a belt, but the intermediate transfer belt is mostly used in the following explanation.

The intermediate transferer of the present invention is preferably used in an image forming apparatus using an intermediate transfer belt [in which plural developed color toner images sequentially formed on an image bearer (photoconductor drum) are sequentially overlapped on the intermediate transfer belt as a first transfer, and then the first transferred image is transferred onto a recording medium as a second transfer.

The intermediate transferer of the present invention includes at least a substrate and may include other layers when necessary. The substrate includes at least a polycarbonate resin and carbon black, and may include other materials when necessary. The intermediate transferer preferably used in the present invention has the shape of a seamless belt. Further, the intermediate transferer needs to have a resistivity satisfying a specified requirement.

The intermediate transferer of the present invention may be have a single-layered structure formed only of a substrate or a multilayered structure including a substrate and other layers layered thereon. The intermediate transferer preferably has the single-layered structure formed only of a substrate because the following resistivities can have preferable ranges.

The other layers include an elastic layer for the purpose of following a transfer medium and a surface layer for the purpose of improving releasability of a toner. Materials forming the elastic layer are no particularly limited, and generic resins, elastomers, rubbers, etc. can be used. The surface layer can be formed with fluorine resins, silicone resins, acrylic resins, etc. A relation between the surface resistivity and the volume resistivity needs controlling so as not to be out of a specific range.

Next, the resistivity of the intermediate transferer is explained.

In the present invention, the intermediate transferer has a surface resistivity of from 10 to 12 Log Ω/□ when applied with a volt of 500 V, a volume resistivity of from 7.5 to 9.5 Log Ω·cm when applied with a volt of 100 V, and a difference between the surface resistivity and the volume resistivity of from 1.5 to 4.0 digits.

The surface resistivity of the intermediate transferer when applied with a volt of 500 V is referred to as surface resistivity (500 V), and the volume resistivity thereof when applied with a volt of 100 V is referred to as volume resistivity (100 V).

When the surface resistivity (500 V) is out of the above range, abnormal images such as white spots and toner scattering are produced. When the volume resistivity (100 V) is out of the above range, abnormal images such as white spots and residual image are produced. When the difference between the resistivity (500 V) and the volume resistivity (100 V) is less than 1.5 digits, the volume resistivity is higher than the surface resistivity, a potential is difficult to decrease and the resultant image tends to have a residual image. When greater than 4.0 digits, the volume resistivity is too low, an electric current is difficult to flow in the surface direction, and an electric field to transfer toner is not fully formed, resulting in production of abnormal images.

The intermediate transferer having the resistivities within the above ranges not only high has transferability but also causes no abnormal images such as white spots.

Carbon black is included in a seamless belt as the intermediate transfer belt in such an amount as to have a surface resistivity (500 V) of from 1×10¹⁰ to 1×10¹²Ω/□ and a volume resistivity (100 V) of from 1×10^{7.5} to 1×10^{9.5} Ω·cm. In terms of mechanical strength, it is preferable that the coated layer is not so fragile as to easily crack. Namely, a polycarbonate resin and an electric resistance controlling material are preferably mixed to balance electrical properties (surface resistivity and volume resistivity) and mechanical strength of the resultant intermediate transfer belt.

The surface resistivity and the volume resistivity are measured by Hiresta UP MCP-HT450 from Mitsubishi Chemical Analytech Co., Ltd. The resistivities after applied with a voltage for 10 sec are measured.

A difference between the surface resistivity (500 V) and the volume resistivity (100 V) of from 1.5 to 4.0 digits means, e.g., the volume resistivity (100 V) is from 1×10⁷ to 1×10^{9.5} Ω·cm when the surface resistivity (500 V) is 1×10¹¹Ω/□.

Dependency of the volume resistivity on a voltage needs considering, and a difference between the volume resistivity at 10 V and that at 100 V is preferably 2 digits or less. When greater than 2 digits, the resultant images occasionally have white spots. A difference between a common logarithm of the volume resistivity at 10 V and that thereof at 100 V is dependency of the volume resistivity on a voltage (10 V/100 V).

### <Polycarbonate Resin>

Next, the polycarbonate resin is explained. The polycarbonate resin for use in the present invention is not particularly limited as long as it is a polymer including a carbonate group (—O—(C═O)—O—). It may be a marketed product or synthesized by known methods. Specifically, the methods include a reaction between bisphenol A and phosgene, an ester polymerization between bisphenol A and diphenyl carbonate, etc.

The marketed products include Iupilon and Iupizeta from Mitsubishi Gas Chemical Company, Inc., Panlite from Teijin Ltd., Toughzet from Idemitsu Kosan Co., Ltd., SD polyca from Sumika Styron Polycarbonate Ltd., etc.

An intermediate transfer belt formed of a polyimide resin has high strength and high surface hardness, it applies high pressure to a toner layer when transferring a toner image, resulting in occasional hollow images because a toner unevenly aggregates and a part of an image is not transferred. In addition, the intermediate transfer belt has low followability with a contact member such as a photoconductor and a paper, resulting in occasional void images because of partial defective contact (gap). Further, polyimide and polyamide imide resins are very expensive.

The polycarbonate resin is not harder than polyimide and polyamideimide, and abnormal images as above are difficult to produce. Polycarbonate has high solubility in a solvent and a solvent in which carbon black is easily dispersed can intentionally be selected. As a result, it is easy to satisfy preferable ranges of the resistivities. Therefore, the polycarbonate resin is more preferably used than the polyimide resins and the polyamideimide resins, and less expensive. In addition, the polyimide resins and the polyamideimide resins need heating at 300 to 400° C. to form an intermediate transfer belt. The polycarbonate resin can be heated at lower temperature and an intermediate transfer belt can be formed in shorter time and at lower cost.

### <Carbon Black>

Next, carbon black is explained. Carbon black is defined as fine spherical particles obtained by incompletely burning various hydrocarbons or compounds including carbons, and is almost a pure carbon material including carbons in an amount not less than 98%. It is broadly classified by methods of forming the carbon black, i.e., thermal decomposition methods and incomplete combustion as follows. It is further classified by materials.

Classification of the carbon black is shown in Table 1.

TABLE 1

| Preparation Methods | | Main Materials |
|---|---|---|
| Thermal | Thermal Methods | Natural Gas |
| Decomposition | Acetylene Decomposition | Acetylene |
| | Methods | |
| Incomplete | Contact Methods (Channel | Natural Gas• Aromatic |
| Combustion | Methods, Gas Black | Oil |
| | Methods, Disc Methods) | |
| | Lamp • Pine Burning | Mineral Oil • Plant Oil |
| | Methods | |
| | Gas Furnace Methods | Natural Gas• Aromatic |
| | | Hydrocarbon Oil |
| | Oil Furnace Methods | Aromatic Hydrocarbon Oil |

Contact methods contact flame to iron or stone and include channel methods, gas black (roller) methods which are improved channel methods, etc.

Channel black is obtained by contact methods contacting flame to the bottom surface of a channel steel.

Furnace methods continuously subject hydrocarbon to thermal decomposition with a combustion heat of fuel air to obtain carbon black, and classified into gas furnace methods and oil furnace methods.

Thermal methods are unique methods periodically repeating combustion and thermal decomposition using natural gas as a carbon source to obtain carbon black having a large particle diameter.

Acetylene black is obtained by a thermal method using acetylene as a material. The thermal decomposition of acetylene is a heat generating reaction although those of other materials are endothermic reactions, and has an advantage of being capable of continuously operating because a combustion cycle in the thermal method can be omitted.

Having higher crytallinity than conventional carbon black and good conductivity, acetylene black is used as a conductivity imparting agent for dry batteries, various rubbers and plastics.

Next, basic properties of the carbon black are explained. Important factors of the carbon black when blended with or dispersed in a rubber, a resin, a coating and a vehicle of ink to impart strength, blackness, conductivity, etc. thereto are particle diameter, structure and physicochemical properties of the surface of particle. These are typically called big three characteristics, and various carbon blacks are produced according to their combinations. For example, combinations of particle diameter, surface area structure, DBP (Dibutyl Phthalate) oiling quantity (ml/100 g), chemical properties of structure index surface, volatile component (%), pH, etc. are considered.

Next, physical properties of the carbon black are explained.

### (Particle Structure)

30 to 40 six-membered carbon rings are combined to form a minimum unit of carbon black. 3 to 5 layers of this net flat surface are layered at almost an equal interval of from 0.35 to 0.39 nm by Van der Waals force to form a crystallite. The crystallites are concentrically and closely located around the surface of a particle, but the inner, the more irregularly located. The more fine particles, the more they have such properties. Thermal black having a large particle size has regular locations almost to the center thereof.

1,000 to 2,000 crystallites are assembled to form a primary particle, and the particles are chemically and physically combined to form a structure.

### (Particle Diameter and Distribution Thereof)

Carbon black particles are fusion-bonded with each other in the shape of spitted groups, and individual particles just form mountains and valleys among groups. When this is regarded as a single particle, the particle diameter has a close relationship with performances such as strength and blackness in various applications.

### (Aggregate and Distribution Thereof)

Carbon black particles form the shape of spitted groups or a grape-shaped aggregate, which is called a structure.

According to growth of the aggregate, the structures are classified into high, normal and low structures. They are important factors largely influencing tensile stress and extrusion properties when blended with a rubber, and dispersibility, blackness, viscosity and conductivity when blended with an ink, a coating vehicle and a resin.

In an oven having a temperature not less than 1,400° C., condensed polycyclic aromatic hydrocarbon having passed a complicated chemical reaction is condensed to a fine droplet to form a core precursor, and the core precursors collide with each other, and are fusion-bonded and solidified to form a structure.

The structure is controlled by selecting the shape of an oven and thermodynamics conditions therein, e.g., a small amount of an alkali metal salt is added.

The structure is measured using an oiling quantity, a compression porosity, a bulk density, analysis of electron microscope image, etc. Oiling quantity which is most typically used is an application of a phenomenon in which carbon black the particles of which are intertwined much, i.e., high structure carbon black absorbs much oil. The structure can be measured by e.g., a DBP absorptometer.

### (Specific Surface Area and Non-Porous Specific Surface Area)

The specific surface area of the carbon black is almost fixed by a size of a single particle. As other solids, the surface has interactions with other materials, and the specific surface area can be said quite an important property. Pores are typically present on the surface of carbon black, and fine gaps are present on the fusion-bonded part between particles.

When the specific surface area is measured, whether the surface area in the pore is included needs to be clearly distinguished. Total specific surface area includes the surface area in the pore. The non-porous specific surface area excludes the surface area in the pore. The specific surface area is measured by BET low-temperature nitrogen adsorption methods or iodine adsorption methods. The non-porous specific surface area is measured by CTAB adsorption methods or “t” methods using an electron microscope.

Next, chemical properties of the carbon black are explained.

### (Element Compositions and Impurities)

Typically, the carbon black includes oxygen, hydrogen, sulfur, ashes, etc.

Hydrogen is a dehydrogenation residue in carbonization process of hydrocarbon. Sulfur is from material oil and fuel oil. Ashes from material oil and cooling water.

Oxygen includes a basic oxide combined when air contacts carbon black particles after formed and an acidic oxide secondly formed from reaction with nitrogen dioxide, ozone and nitric acid. Both of them are thought present on the surface of a particle.

Sulfur is chemically combined or released. Released sulfur is abstractable with a solvent or sulfurized alkali aqueous solution. Combined sulfur is not completely released even at 1,000° C.

Ashes include chlorides and sulfates of sodium and magnesium, calcium carbonates, iron oxides, silica, etc. These are more included in furnace black than channel black.

### (Surface Functional Group)

Most of chemical reactions of the carbon back come from chemical functional groups known as oxides and active hydrogen, etc. on the surface.

Specific examples of functional groups of acidic oxides include carboxyl groups, hydroxyl groups, quinone groups, lactone groups, etc. These are specified with volatile component compositions and quantities, and pH, etc. The volatile component is a reduced amount when conductive carbon black (having a surface resistivity approximately of form 10⁻¹ to 10⁴/□) is heated at 950° C. for 7 min. Typically, the more the functional groups on the surface, the more the volatile components. pH is measured by measuring a mixed liquid including carbon black and distilled water with a glass-polar pH meter.

The carbon black preferably has a pH not greater than 4, and more preferably not greater than 3.5. The carbon black preferably has a volatile component not greater than 3.5%, and more preferably not greater than 3%. When pH is greater than 4, the resultant intermediate transferer has too small a difference between the surface resistivity (500 V) and the volume resistivity (100 V). Namely, since the volume resistivity is too high relative to the surface resistivity, the potential is difficult to decrease and the resultant image tends to have residual images.

When volatile component is greater than 3.5%, the resultant intermediate transferer has too large a difference between the surface resistivity (500 V) and the volume resistivity (100 V). Namely, since the volume resistivity is too low, an electric current is difficult to flow in the surface direction, and an electric field to transfer toner is not fully formed, resulting in production of abnormal images.

Marked carbon black may be used. MA7, MA8, MA11, MA77, MA78, MA100 and MA100R from Mitsubishi Chemical Corp. are available from the market as typical generic carbon black.

Dispersants may be used to improve dispersibility of the carbon black. Specific examples include known pigment dispersants used for dispersing pigments, such as DISPERBYK-130, DISPERBYK-161, DISPERBYK-162, DISPERBYK-163, DISPERBYK-166, DISPERBYK-170, DISPERBYK-171, DISPERBYK-174, DISPERBYK-180, DISPERBYK-182, DISPERBYK-183, DISPERBYK-184, DISPERBYK-185, DISPERBYK-2000, DISPERBYK-2001, DISPERBYK-2050, DISPERBYK-2070, DISPERBYK-2096, DISPERBYK-2150, DISPERBYK-2155 from BYK-Chemie GmbH; and Solsperse 3000, Solsperse 9000, Solsperse 13240, Solsperse 13650, Solsperse 11200, Solsperse 13940, Solsperse 17000, Solsperse 18000, Solsperse 20000, Solsperse 21000, Solsperse 22000, Solsperse 24000, Solsperse 26000, Solsperse 27000, Solsperse 28000, Solsperse 32000, Solsperse 36000, Solsperse 37000, Solsperse 38000, Solsperse 41000, Solsperse 42000, Solsperse 43000, Solsperse 46000, Solsperse 54000, Solsperse 71000 from The Lubrizol Corporation.

In addition to the above, additives such as a flame retardant, a reinforcer, a lubricant, a heat conductive material and antioxidant. A carbonate resin and other resins may be mixed, and the intermediate transferer may have two or more layers such as surface layer to improve transferability of a toner and an elastic layer to improve followability to concave and convex papers.

The intermediate transferer preferably has a thickness of from 50 to 90 μm, and more preferably from 60 to 80 μm to have good durability. When less than 50 μm, the belt is easy to tear due to cracks. When greater than 90 μm, the belt occasionally cracks when bent. The thickness can be measured by a contact type or an eddy current type thickness meter, or the cross-section of the film is measured by a SEM.

In the present invention, a coating liquid for the intermediate transferer preferably includes carbon black in an amount of from 10 to 30% by weight, and more preferably from 15 to 25% by weight based on total weight of solid contents. When less than 10% by weight, uniformity of the resistivity is difficult to obtain and the resistivity largely varies according to arbitrary potentials. When greater than 30% by weight, the intermediate transfer best lowers in mechanical strength, which is unfavorable in practical use.

Methods of dispersing carbon black in a polycarbonate resin include dispersing carbon black under the presence of an organic solvent to prepare a dispersion and mixing a resin liquid in which polycarbonate resin is dissolved in an organic solvent with the dispersion to prepare a coating liquid (wet dispersion). Alternatively, polycarbonate resin and carbon black are melted are melted and kneaded (dry dispersion) with a heat nor lower than a glass transition temperature of the resin.

Wet dispersion is typically made by beads mill and dry dispersion by kneader. The wet dispersion is preferably used in terms of controlling the surface resistivity, the volume resistivity and the thickness in preferable ranges. The dry dispersion is not only difficult to mold a size of 90 μm or less, but also tends to increase the volume resistivity. There is almost no difference between the surface resistivity (500 V) and the volume resistivity (100 V).

Next, an embodiment of methods of preparing the intermediate transfer belt of the present invention is explained.

The methods are broadly classified into the above two dry or wet dispersion type. The former is an extrusion mold heating a cylindrical mold and extruding a melted and kneaded material to form a belt, and the latter applies a coating liquid on the inner surface or the outer surface of a cylindrical mold and heating the liquid to form a belt.

The extrusion mold applies a string shearing force in the belt width direction and carbon black tends to aggregate, i.e., the resistance varies, and further the volume resistivity tends to be high relative to the surface resistivity. It is difficult to form a belt having a thickness not greater than 120 μm, i.e., easy to crack, and therefore it is preferable to heat a coating liquid. Namely, the intermediate transferer of the present invention is preferably formed by dispersing carbon black under the presence of an organic solvent to prepare a dispersion, mixing a resin liquid in which polycarbonate resin is dissolved in an organic solvent with the dispersion to prepare a coating liquid, applying the coating liquid on a mold, and drying the liquid.

A method of applying a coating liquid on the outer surface of a mold and heating the liquid to prepare an intermediate transfer belt is explained.

While a cylindrical metallic mold is slowly rotated, a coating liquid including a resin component is uniformly applied by a liquid applicator such as a nozzle and a dispenser on the whole outer surface of the cylinder to form a coating film.

Then, the rotational speed is increased to a predetermined speed. The speed is maintained and the rotation is continued for a desired time. While rotated and gradually heated, a solvent in the coating film is evaporated at from 80 to 120° C. In this process, it is preferable to efficiently circulate and remove vapors in atmosphere such as volatilized solvents. Next, the temperature is increased to 140 to 170° C. to completely volatilize the solvent. Since the belt includes many air bubbles if the temperature is quickly increased to 140 to 170° C., drying is preferably made twice. After fully cooled, the mold is removed to prepare an intermediate transfer belt.

The solvent is not particularly limited, and known solvents such as cyclohexanone, methyl-n-amyl ketone (MAK), tetrahydrofuran (THF), acetic acid, ethyl acetate, butyl acetate, methyl ethyl ketone (MEK), methyl isobutyl ketone (MIBK), dichlorobenzene and dimethylformamide (DMF).

### <Image Forming Apparatus>

The image forming apparatus of the present invention includes an image bearer a latent image is formed on and capable of bearing a toner image, an image developer developing the latent image formed on the image bearer with a toner, an intermediate transferer a toner image developed by the image developer is first transferred onto, and a transferer second transferring the toner image borne on the intermediate transferer to a recording medium, and other means such as a discharger, a cleaner, a recycler and a controller when necessary. The intermediate transferer of the present invention is used as the intermediate transferer.

In this case, the image forming apparatus is preferably a full-color image forming apparatus in which plural image bearers having an image developer for each color are located in series.

Referring now to the schematic views of essential parts, detail description will next be given to a seamless belt used in the belt constitution section of an image forming apparatus of the present invention. Note that the schematic views are exemplary ones, which should not be construed as limiting the present invention thereto.

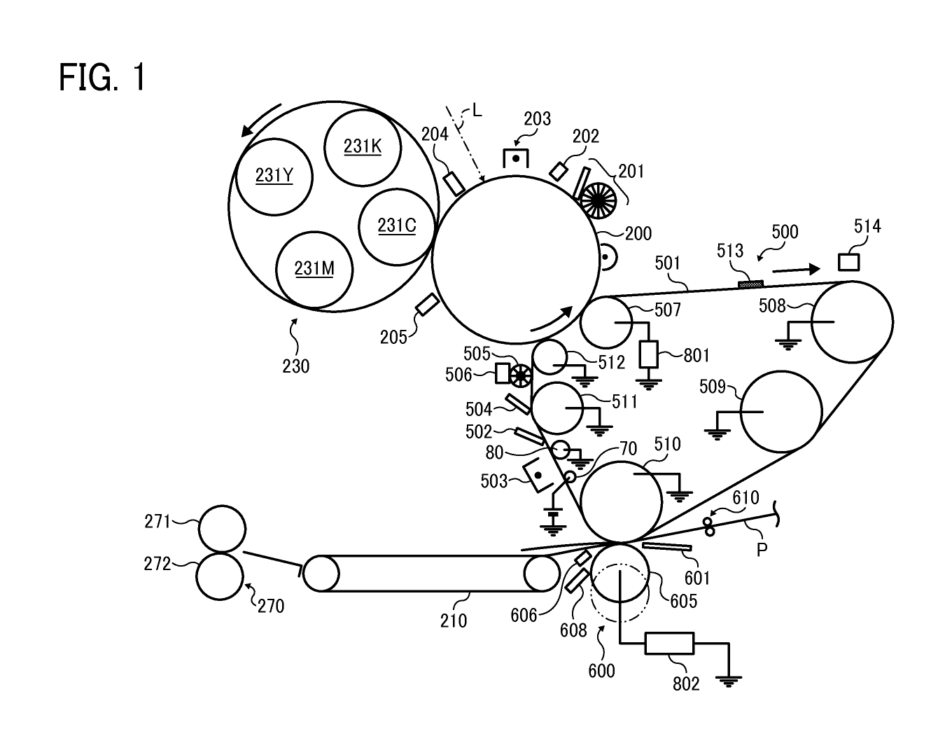

FIG. 1 is a schematic view illustrating a main part of an embodiment of image forming apparatus equipped with the intermediate transferer of the present invention as a belt member. As shown in FIG. 1, an intermediate transfer unit 500 including a belt member, includes an intermediate transfer belt 501 as an intermediate transfer medium stretched around a plurality of rollers. Around the intermediate transfer belt 501, a secondary transfer bias roller 605 serving as a secondary transfer charge applying unit of a secondary transfer unit 600, a belt cleaning blade 504 as a cleaning unit for the intermediate transfer medium, and a lubricant applying brush 505 as a lubricant applying member of a lubricant applying unit, etc. are disposed facing the intermediate transfer belt 501.

An unillustrated position detection mark is located on the outer circumferential surface or on the inner circumferential surface of the intermediate transfer belt 501. However, since the position detection mark on the outer circumferential surface needs to avoid a passage of the belt cleaning blade 504, the position detection mark may be located on the inner circumferential surface of the intermediate transfer belt 501. An optical sensor 514 as the mark detection sensor is located between a primary transfer bias roller 507 and a driving roller 508 the intermediate transfer belt 501 is stretched around.

The intermediate transfer belt 501 is stretched around the primary transfer bias roller 507 serving as a primary transfer charge applying unit, the belt driving roller 508, a belt tension roller 509, a secondary transfer opposing roller 510, a cleaning opposing roller 511, and a feedback current detecting roller 512. Each roller is formed of a conductive material, and respective rollers other than the primary transfer bias roller 507 are grounded. A transfer bias is applied to the primary transfer bias roller 507, the transfer bias being controlled at a predetermined level of current or voltage according to the number of superimposed toner images by means of a primary transfer power source 801 controlled at a constant current or a constant voltage.

The intermediate transfer belt 501 is driven in the direction indicated by an arrow by the belt driving roller 508, which is driven to rotate in the direction indicated by an arrow by a driving motor (not shown).

The intermediate transfer belt 501 serving as the belt member is generally semiconductive or insulative, and has a single layer or a multi-layer structure. In the present invention, a seamless belt is preferably used, so as to improve durability and attain excellent image formation. Moreover, the intermediate transfer belt is larger than the maximum size capable of passing paper so as to superimpose toner images formed on a photoconductor drum 200.

The secondary transfer bias roller 605 is a secondary transfer unit, which is configured to be brought into contact with a portion of the outer surface of the intermediate transfer belt 501, which is stretched around the secondary transfer opposing roller 510 by means of an attaching/detaching mechanism as an attaching/detaching unit described below. The secondary transfer bias roller 605 which is disposed so as to hold a transfer paper P with a portion of the intermediate transfer belt 501 which is stretched around the secondary transfer opposing roller 510, is applied with a transfer bias of a predetermined current by the secondary transfer power source 802 controlled at a constant current.

A pair of registration rollers 610 feeds the transfer paper P as a transfer medium at a predetermined timing in between the secondary transfer bias roller 605 and the intermediate transfer belt 501 stretched around the secondary transfer opposing roller 510. With the secondary transfer bias roller 605, a cleaning blade 608 as a cleaning unit is in contact. The cleaning blade 608 performs cleaning by removing deposition deposited on the surface of the secondary transfer bias roller 605.

In a color copying machine having the above-mentioned construction, when an image formation cycle is started, the photoconductor drum 200 is rotated by a driving motor (not shown) in a counterclockwise direction indicated by an arrow, so as to form Bk (black), C (cyan), M (magenta), and Y (yellow) toner images on the photoconductor drum 200. The intermediate transfer belt 501 is driven in the direction of the arrow by means of the belt driving roller 508. Along with the rotation of the intermediate transfer belt 501, a formed Bk-toner image, a formed C-toner image, a formed M-toner image, and a formed Y-toner image are primarily transferred by means of a transfer bias based on a voltage applied to the primary transfer bias roller 507. Finally, the images are superimposed on one another in order of Bk, C, M, and Y on the intermediate transfer belt 501, to thereby form a color image. The order of the toner image formation is not particularly limited thereto.

For example, the Bk toner image is formed as follows.

In FIG. 1, a charger 203 uniformly charges a surface of the photoconductor drum 200 to a predetermined potential with a negative charge by corona discharging. Subsequently, at a timing determined based on signals for detecting marks on the belt, by the use of an optical writing unit (not shown) raster exposure is performed based on a Bk color image signal. When the raster image is exposed, a charge proportional to an amount of light exposure is removed and a Bk latent electrostatic image is thereby formed, in an exposed portion of the photoconductor drum 200 which has been uniformly charged. Then, by bringing a Bk toner charged to a negative polarity on the Bk developing roller of a Bk developing unit 231K into contact with the Bk latent electrostatic image, the Bk toner does not adhere to a portion where a charge remaining on the photoconductor drum 200, and the Bk toner adsorbs to a portion where there is no charge on the photoconductor drum 200, in other words a portion exposed to the raster light exposure, to thereby form a Bk toner image corresponding to the latent electrostatic image.

The Bk toner image formed on the photoconductor drum 200 is primarily transferred to the outer surface of the intermediate transfer belt 501 being in contact with the photoconductor drum 200, in which the intermediate transfer belt 501 and the photoconductor drum 200 are driven at an equal speed. After primary transfer, slightly remaining toner which has not been transferred from the photoconductor drum 200 to the intermediate transfer belt 501 is cleaned with a photoconductor cleaning unit 201 in preparation for a next image forming operation on the photoconductor drum 200. Next to the Bk image forming process, the operation of the photoconductor drum 200 then proceeds to a C image forming process, in which C image data is read with a color scanner at a predetermined timing, and a C latent electrostatic image is formed on the photoconductor drum 200 by a write operation with laser light based on the C image data.

A revolver development unit 230 is rotated after the rear edge of the Bk latent electrostatic image has passed and before the front edge of the C latent electrostatic image reaches, and the C developing unit 231C is set to a developing position, where the C latent electrostatic image is developed with C toner. From then on, development is continued over the area of the C latent electrostatic image, and at the point of time when the rear edge of the C latent electrostatic image has passed, the revolver development unit rotates in the same manner as the previous case of the Bk developing unit 231K to allow the M developing unit 231M to move to the developing position. This operation is also completed before the front edge of a Y latent electrostatic image reaches the developing position. As for M and Y image forming steps, the operations of scanning respective color image data, the formation of latent electrostatic images, and their development are the same as those of Bk and C, therefore, explanation of the steps is omitted.

Bk, C, M, and Y toner images sequentially formed on the photoconductor drum 200 are sequentially registered in the same plane and primarily transferred onto the intermediate transfer belt 501. Accordingly, the toner image whose four colors at the maximum are superimposed on one another is formed on the intermediate transfer belt 501. The transfer paper P is fed from the paper feed section such as a transfer paper cassette or a manual feeder tray at the time when the image forming operation is started, and waits at the nip of the registration rollers 610.

The registration rollers 610 are driven so that the front edge of the transfer paper P along a transfer paper guide plate 601 just meets the front edge of the toner image when the front edge of the toner image on the intermediate transfer belt 501 is about to reach a secondary transfer section where the nip is formed by the secondary transfer bias roller 605 and the intermediate transfer belt 501 stretched around the secondary transfer opposing roller 510, and registration is performed between the transfer paper P and the toner image.

When the transfer paper P passes through the secondary transfer section, the four-color superimposed toner image on the intermediate transfer belt 501 is collectively transferred (secondary transfer) onto the transfer paper P by transfer bias based on the voltage applied to the secondary transfer bias roller 605 by the secondary transfer power source 802. When the transfer paper P passes through a portion facing a transfer paper discharger 606 formed of charge eliminating spines and disposed downstream of the secondary transfer section in a moving direction of a transfer paper guiding plate 601, a charge on the transfer paper sheet is removed and then the transfer paper P is separated from the transfer paper guiding plate 601 to be delivered to a fixing unit 270 via the belt transfer unit 210 which is included in the belt constitution section.

Furthermore, a toner image is then fused and fixed on the transfer paper P at a nip portion between fixing rollers 271 and 272 of the fixing unit 270, and the transfer paper P is then discharged outside of a main body of the apparatus by a discharging roller (not shown) and is stacked in a copy tray (not shown) with a front side up. The fixing unit 270 may have a belt constitution section.

On the other hand, the surface of the photoconductor drum 200 after the toner images are transferred to the belt is cleaned by the photoconductor cleaning unit 201, and is uniformly discharged by a discharge lamp 202. After the toner image is secondarily transferred to the transfer paper P, the toner remaining on the outer surface of the intermediate transfer belt 501 is cleaned by the belt cleaning blade 504. The belt cleaning blade 504 is configured to be brought into contact with the outer surface of the intermediate transfer belt 501 at a predetermined timing by the cleaning member attaching/detaching mechanism not shown in the figure.

On an upstream side from the belt cleaning blade 504 with respect to the rotating direction of the intermediate transfer belt 501, a toner sealing member 502 is provided so as to be brought into contact with the outer surface of the intermediate transfer belt 501. The toner sealing member 502 is configured to receive the toner particles scraped off with the belt cleaning blade 504 during cleaning of the remaining toner, so as to prevent the toner particles from being scattered on a conveyance path of the transfer paper P. The toner sealing member 502, together with the belt cleaning blade 504, is brought into contact with the outer surface of the intermediate transfer belt 501 by the cleaning member attaching/detaching mechanism.

To the outer surface of the intermediate transfer belt 501 from which the remaining toner has been removed, a lubricant 506 is applied by scraping it with a lubricant applying brush 505. The lubricant 506 is formed of zinc stearate, etc. in a solid form, and disposed to be brought into contact with the lubricant applying brush 505. The charge remaining on the outer surface of the intermediate transfer belt 501 is removed by discharge bias applied with a belt discharging brush (not shown), which is in contact with the outer surface of the intermediate transfer belt 501. The lubricant applying brush 505 and the belt discharging brush are respectively configured to be brought into contact with the outer surface of the intermediate transfer belt 501 at a predetermined timing by means of an attaching/detaching mechanism (not shown).

When the copying operation is repeated, in order to perform an operation of the color scanner and an image formation onto the photoconductor drum 200, an operation proceeds to an image forming process of a first color (Bk) of a second sheet at a predetermined timing subsequent to an image forming process of the fourth color (Y) of the first sheet. As for the intermediate transfer belt 501, a Bk toner image of the second sheet is primarily transferred to the outer surface of the intermediate transfer belt 501 in an area of which has been cleaned by the belt cleaning blade 504 subsequent to a transfer process of the toner image of four colors on the first sheet of the transfer paper. Then, the same operations are performed for a next sheet as for the first sheet.

Operations have been described in a copy mode in which full-color copies of four colors are obtained. The same operations are performed the number of corresponding times for specified colors in copy modes of three or two colors. In a monochrome-color copy mode, only the developing unit of a predetermined color in the revolver development unit 230 is put in a development active state until the copying operation is completed for the predetermined number of sheets, and the belt cleaning blade 504 is kept in contact with the intermediate transfer belt 501 while the copying operation is continuously performed.

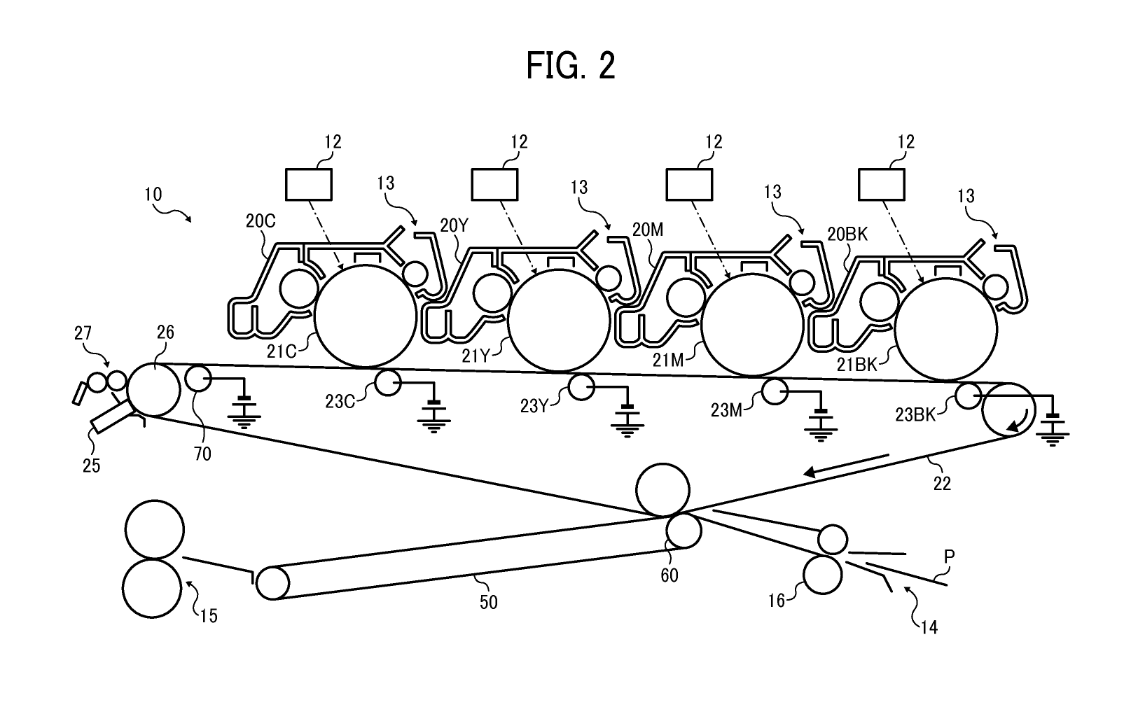

In the above-mentioned embodiment, a copier having only one photoconductor drum 200 is described. However, the electrophotographic intermediate transfer belt of the present invention can be used, for example, in a tandem type image forming apparatus as shown in FIG. 2, in which a plurality of photoconductor drums are serially arranged along an intermediate transfer belt formed in the seamless belt.

FIG. 2 is a schematic view illustrating another embodiment of image forming apparatus, i.e., a digital full-color printer equipped with the intermediate transferer of the present invention as a belt member, including 4 photoconductor drums 21BK, 21Y, 21M and 21C forming black (Bk), magenta (M), yellow (Y) and cyan (C) toner images, respectively.

In FIG. 2, a main body of a printer 10 is constituted with image writing sections 12, image forming sections 13, paper feeding sections 14, for electrophotographic color image formation. Based on image signals, image processing operation is performed in an image processing section, and converted to color signals of black (Bk), magenta (M), yellow (Y), and cyan (C), and then color signals are transmitted to the image writing sections 12. The image writing sections 12 are laser scanning optical systems each including a laser light source, a deflector such as a rotary polygon mirror, a scanning imaging optical system, and mirrors, and have four optical writing paths corresponding to color signals, and perform image writing corresponding to respective color signals on image bearing members (photoconductors) 21Bk, 21M, 21Y, 21C provided for respective colors in the image forming sections 13.

The image forming sections 13 includes four photoconductors 21Bk, 21M, 21Y and 21C serving as image bearing member for Black (Bk), magenta (M), yellow (Y) and cyan (C), Generally, organic photoconductors are used as these photoconductors. Around each of the photoconductors 21Bk, 21M, 21Y, 21C, a charging unit, an exposure portion irradiated with laser beam from the image writing section 12, each of developing units 20Bk, 20M, 20Y, 20C, each of primary transfer bias rollers 23Bk, 23M, 23Y, 23C as a primary transfer unit, a cleaning unit (abbreviated), and other devices such as a discharging unit for the photoconductor (not shown) are arranged. Each of the developing units 20Bk, 20M, 20Y, 20C uses a two component magnet brush developing method. An intermediate transfer belt 22, which is the belt constitution section, is located between each of the photoconductors 21Bk, 21M, 21Y, 21C and each of the primary transfer bias rollers 23Bk, 23M, 23Y, 23C. Black (Bk), magenta (M), yellow (Y) and cyan (C) color toner images formed on the photoconductors 21Bk, 21M, 21Y, 21C are sequentially superimposingly transferred to the intermediate transfer belt 22.

A transfer paper P fed from the paper feeding section 14 is fed via a registration roller 16 and then held by a transfer conveyance belt 50 as a belt constitution section. The toner images transferred onto the intermediate transfer belt 22 are secondarily transferred (collectively transferred) to the transfer paper P by a secondary transfer bias roller 60 as a secondary transfer unit at a point in which the intermediate transfer belt 22 is brought into contact with the transfer conveyance belt 50. Thus, a color image is formed on the transfer paper P. The transfer paper P on which the color image is formed is fed to a fixing unit 15 via the transfer conveyance belt 50, and the color image is fixed on the transfer paper P by the fixing unit 15, and then the transfer paper P is discharged from the main body of the printer.

Toner particles remaining on the surface of the intermediate transfer belt 22, which has not been transferred in the secondary transfer process, are removed by a belt cleaning member 25. On a downstream side from the belt cleaning member 25 with respect to the rotation direction of the intermediate transfer belt 22, a lubricant applying unit 27 is provided. The lubricant applying unit 27 includes a solid lubricant and a conductive brush configured to rub the intermediate transfer belt 22 so as to apply the solid lubricant to the surface of the intermediate transfer belt 22. The conductive brush is constantly in contact with the intermediate transfer belt 22, so as to apply the solid lubricant to the intermediate transfer belt 22. The solid lubricant is effective to improve the cleanability of the intermediate transfer belt 22, thereby preventing occurrence of filming thereon, and improving durability of the intermediate transfer belt 22.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

The surface resistivity and the volume resistivity of the intermediate transfer belt were measured by Hiresta UP MCP-HT450 from Mitsubishi Chemical Analytech Co., Ltd. The resistivities after applied with a voltage for 10 sec were measured. The average thickness thereof was an average value of the values of the thickness measured at arbitrarily selected 12 spots. The thickness was measured by a thickness meter KG3001 indicator from Anritsu Corporation. Dependency of the volume resistivity on a voltage is a value from dividing a resistivity when the belt is applied with 10 V by that when applied with 100 V (10 V/100 V).

### Example 1

### Preparation of Polycarbonate Coating Liquid A

First, a polycarbonate resin (Lupizeta PCZ-800 from Mitsubishi Gas Chemical Company, Inc.) was dissolved in cyclohexanone (Kanto Chemical Co., Inc.) to prepare a solution. Next, the solution was mixed with a dispersion in which carbon black (MA11 having a pH of 3.5 and a volatile component of 1.6% from Mitsubishi Chemical Corp.) was dispersed by a ball mill for 12 hrs in cyclohexanone, to prepare a [polycarbonate coating liquid A]. The coating liquid included a solid content in an amount of 20% by weight, and the solid content included the carbon black in an amount of 19% by weight.

### Preparation of Intermediate Transfer Belt A

The polycarbonate coating liquid A was uniformly coated by a dispenser on a blasted (roughened) outer surface of a metallic cylindrical mold having an outer diameter of 375 mm and a length of 360 mm while rotated at 50 rpm. After the coating liquid was uniformly coated, the cylindrical mold was placed in a drier while rotated at 100 rpm. The cylindrical mold was gradually heated up to have a temperature of 100° C. for 60 min. Further, the cylindrical mold was gradually heated up to have a temperature of 150° C. for 30 min. The rotation was stopped, and the cylindrical mold a film was formed on was taken out after cooled to prepare an [intermediate transfer belt A].

The belt had a thickness of 70 μm, a surface resistivity (500 V) of 10.5 Log Ω/□, a volume resistivity (100 V) of 8.6 Log Ω·cm and a dependency thereof on voltage (10 V/100 V) of 0.9 digits.

### Example 2

### Preparation of Intermediate Transfer Belt B

The procedure for preparation of the intermediate transfer belt A in Example 1 was repeated except for changing the thickness into 100 μm. The belt had a surface resistivity (500 V) of 10.4 Log Ω/□, a volume resistivity (100 V) of 8.3 Log Ω·cm and a dependency thereof on voltage (10 V/100 V) of 0.9 digits.

### Example 3

### Preparation of Intermediate Transfer Belt C

The procedure for preparation of the intermediate transfer belt A in Example 1 was repeated except for changing the thickness into 40 μm. The belt had a surface resistivity (500 V) of 10.6 Log Ω/□, a volume resistivity (100 V) of 8.8 Log Ω·cm and a dependency thereof on voltage (10 V/100 V) of 1.0 digit.

### Example 4

### Preparation of Intermediate Transfer Belt D

The procedure for preparation of the intermediate transfer belt A in Example 1 was repeated except for replacing the carbon black MA11 with MA77 having a pH of 2.5 and a volatile component of 2.8% from Mitsubishi Chemical Corp. The belt had a thickness of 70 nm, a surface resistivity (500 V) of 11.9 Log Ω/□, a volume resistivity (100 V) of 8.5 Log Ω·cm and a dependency thereof on voltage (10 V/100 V) of 2.2 digits.

### Example 5

### Preparation of Intermediate Transfer Belt E

The procedure for preparation of the intermediate transfer belt A in Example 1 was repeated except for replacing the carbon black MA11 with Printex U having a pH of 4.5 and a volatile component of 5% from Orion Engineered Carbons. The belt had a thickness of 70 μm, a surface resistivity (500 V) of 10.9 Log Ω/□, a volume resistivity (100 V) of 9.4 Log Ω·cm and a dependency thereof on voltage (10 V/100 V) of 1.9 digits.

### Example 6

### Preparation of Intermediate Transfer Belt F

The procedure for preparation of the intermediate transfer belt A in Example 1 was repeated except for replacing the carbon black MA11 with MA100 having a pH of 3.5 and a volatile component of 1.5% from Mitsubishi Chemical Corp. The belt had a thickness of 70 nm, a surface resistivity (500 V) of 10.2 Log Ω/□, a volume resistivity (100 V) of 7.6 Log Ω·cm and a dependency thereof on voltage (10 V/100 V) of 0.7 digits.

### Comparative Example 1

### Preparation of Melted and Kneaded Material G

Nine (9)% by weight of carbon black Denka Black having a pH of from 9 to 10 and a volatile component of 0.16% from Denki Kagaku Kogyo Kabushiki Kaisha were added to a polycarbonate resin (Lupizeta PCZ-800 from Mitsubishi Gas Chemical Company, Inc.), and kneaded by a kneader at 150° C. for 80 min. Further, a conductive agent was dispersed with the kneaded mixture by a two-roll mill for 30 min, and pelletized by a pelletizer to prepare a pellet-shaped [melted and kneaded material G].

### Preparation of Intermediate Transfer Belt G

The pellet-shaped melted and kneaded material G was extruded by a circular die in the shape of a cylinder to prepare an [intermediate transfer belt G]. The belt had a thickness of 130 μm, a surface resistivity (500 V) of 11.2 Log Ω/□, a volume resistivity (100 V) of 10.2 Log Ω·cm and a dependency thereof on voltage (10 V/100 V) of 1.3 digits.

### Comparative Example 2

### Preparation of Intermediate Transfer Belt H

The procedure for preparation of the intermediate transfer belt G in Comparative Example 1 was repeated except for changing the addition quantity of the carbon black from 9 to 10.2% by weight. The belt had a thickness of 130 μm, a surface resistivity (500 V) of 9.5 Log Ω/□, a volume resistivity (100 V) of 8.7 Log Ω·cm and a dependency thereof on voltage (10 V/100 V) of 1.1 digits.

### Comparative Example 3

### Preparation of Polycarbonate Coating Liquid I

First, a polycarbonate resin (Lupizeta PCZ-800 from Mitsubishi Gas Chemical Company, Inc.) was dissolved in a mixture of tetrahydrofuran (THF) and toluene (THF/toluene=70/30) from Denki Kagaku Kogyo Kabushiki Kaisha to prepare a solution. Next, the solution was mixed with a dispersion in which carbon black (Special Black 4 having a pH of 3 and a volatile component of 14% from Orion Engineered Carbons) was dispersed by a ball mill for 12 hrs in the mixture of tetrahydrofuran (THF) and toluene (THF/toluene=70/30), to prepare a [polycarbonate coating liquid I]. The coating liquid included a solid content in an amount of 15% by weight, and the solid content included the carbon black in an amount of 12.8% by weight.

### Preparation of Intermediate Transfer Belt I

The procedure for preparation of the intermediate transfer belt A in Example 1 was repeated except for replacing the [polycarbonate coating liquid A] with the [polycarbonate coating liquid I]. The belt had a thickness of 80 μm, a surface resistivity (500 V) of 11.9 Log Ω/□, a volume resistivity (100 V) of 7.3 Log Ω·cm and a dependency thereof on voltage (10 V/100 V) of 2.6 digits.

### Comparative Example 4

### Preparation of Intermediate Transfer Belt J

The procedure for preparation of the intermediate transfer belt H in Comparative Example 3 was repeated except for changing the amount of the carbon black in the solid content from 12.8 to 12.0% by weight. The belt had a thickness of 80 μm, a surface resistivity (500 V) of 12.6 Log Ω/□, a volume resistivity (100 V) of 7.6 Log Ω·cm and a dependency thereof on voltage (10 V/100 V) of 2.8 digits.

Each of the properties of the belts prepared in Examples 1 to 6 and Comparative Example 1 to 4 are shown in Table 2. A surface resistivity thereof when applied with a volt of 500 V is represented by ρs500, a volume resistivity thereof when applied with a volt of 100 V is represented by ρv100, and a difference between a common logarithm of ρs500 and that of ρv100 is represented by resistivity difference. A difference between a common logarithm of the volume resistivity at 10 V and that thereof at 100 V (10 V/100 V) is represented by ρv voltage dependency.

TABLE 2

| | | | | Carbon Black | | |
|---|---|---|---|---|---|---|
| | | | Thick- | | | Volatile |
| | | Molding | ness | | | Component |
| | Belt | Method | (μm) | Name | pH | (%) |
| Example 1 | A | Wet | 70 | MA11 | 3.5 | 1.6 |
| Example 2 | B | Wet | 100 | MA11 | 3.5 | 1.6 |
| Example 3 | C | Wet | 40 | MA11 | 3.5 | 1.6 |
| Example 4 | D | Wet | 70 | MA77 | 2.5 | 2.8 |
| Example 5 | E | Wet | 70 | Printex | 4.5 | 5.0 |
| | | | | U | | |
| Example 6 | F | Wet | 70 | MA100 | 3.5 | 1.6 |
| Comparative | G | Extrusion | 130 | Denka | 9 to | 0.16 |
| Example 1 | | | | Black | 10 | |
| Comparative | H | Extrusion | 130 | Denka | 9 to | 0.16 |
| Example 2 | | | | Black | 10 | |
| Comparative | I | Wet | 80 | Special | 3.0 | 14 |
| Example 3 | | | | Black 4 | | |
| Comparative | J | Wet | 80 | Special | 3.0 | 14 |
| Example 4 | | | | Black 4 | | |

| | | | Electric Properties | | | |
|---|---|---|---|---|---|---|
| | | | | | | ρv |
| | | | | | | Voltage |
| | | Poly- | ρs 500 | ρv 100 | Resistivity | Depen- |
| | | carbonate | (Log | (Log | Difference | dency |
| | Belt | Name | Ω/□) | Ω · cm) | (digit) | (digit) |
| Example 1 | A | PCZ-800 | 10.5 | 8.6 | 1.9 | 0.9 |
| Example 2 | B | PCZ-800 | 10.4 | 8.3 | 2.1 | 0.9 |
| Example 3 | C | PCZ-800 | 10.6 | 8.8 | 1.8 | 1.0 |
| Example 4 | D | PCZ-800 | 11.9 | 8.5 | 3.4 | 2.2 |
| Example 5 | E | PCZ-800 | 10.9 | 9.4 | 1.5 | 1.9 |
| Example 6 | F | PCZ-800 | 10.2 | 7.6 | 2.6 | 0.7 |
| Comparative | G | PCZ-800 | 11.2 | 10.2 | 1.0 | 1.3 |
| Example 1 | | | | | | |
| Comparative | H | PCZ-800 | 9.5 | 8.7 | 0.8 | 1.1 |
| Example 2 | | | | | | |
| Comparative | I | PCZ-800 | 11.9 | 7.3 | 4.6 | 2.6 |
| Example 3 | | | | | | |
| Comparative | J | PCZ-800 | 12.6 | 7.6 | 5.0 | 2.8 |
| Example 4 | | | | | | |

Each of the intermediate transfer belts A to J of each Example and Comparative Example was installed in imagio MPC7501 from Ricoh Company, Ltd, and each 10 solid images, halftone images and thine line images were produced thereby on TYPE 6200 paper from Ricoh Company, Ltd. in an environment of 10° C. and 15% RH to evaluate images. Toner scattering, white spots, residual images and uneven image density were evaluated.

Good: Ten images had no abnormality

Fair: Partly abnormal, but usable

Poor: Unusable

Further, 100,000 images were produced to evaluate durability. The evaluation was stopped when the belt broke on the way. The belt B cracked after 70,000 images were produced and the belt C cracked at the edge after 80,000 images were produced. The belts I and J cracked after 40,000 images were produced. The other bests did not break even after 100,000 images were produced.

TABLE 3

| | | Image Evaluation | | | |
|---|---|---|---|---|---|
| | | Toner | White | Residual | Uneven Image |
| | Belt | Scattering | Spots | Image | Density |
| Example 1 | A | Good | Good | Good | Good |
| Example 2 | B | Good | Good | Good | Good |
| Example 3 | C | Good | Good | Good | Good |
| Example 4 | D | Good | Fair | Good | Good |
| Example 5 | E | Good | Good | Fair | Good |
| Example 6 | F | Good | Good | Good | Good |
| Comparative | G | Good | Fair | Poor | Fair |
| Example 1 | | | | | |
| Comparative | H | Poor | Poor | Good | Fair |
| Example 2 | | | | | |
| Comparative | I | Fair | Poor | Good | Fair |
| Example 3 | | | | | |
| Comparative | J | Poor | Poor | Good | Fair |
| Example 4 | | | | | |

Having now fully described the invention, it will be apparent to one of ordinary skill in the art that many changes and modifications can be made thereto without departing from the spirit and scope of the invention as set forth therein.

What is claimed is:

1. An intermediate transferer a toner image formed by developing a latent image on an image bearer with a toner is transferred onto, comprising a substrate comprising:
a polycarbonate resin; and
a carbon black
wherein the intermediate transferer has a surface resistivity of from 10 to 12 Log Ω/□ when applied with a volt of 500 V, a volume resistivity of from 7.5 to 9.5 Log Ω·cm when applied with a volt of 100 V, and a difference between the surface resistivity and the volume resistivity of from 1.5 to 4.0 digits.

2. The intermediate transferer of claim 1, wherein the carbon black has a pH not greater than 4 and a volatile component not greater than 3.5%.

3. The intermediate transferer of claim 1, wherein the volume resistivity has dependency on voltage which is a ratio (10 V/100 V) of the volume resistivity when the transferer is applied with 10 V to that when applied with 100 V not greater than 2 digits.

4. The intermediate transferer of claim 1, wherein the intermediate transferer has a thickness of from 50 to 90 μm.

5. The intermediate transferer of claim 1, wherein the intermediate transferer is formed by applying a coating liquid to a metallic mold and drying the liquid, comprising:
a polycarbonate resin solution, comprising:
a first solvent; and
a polycarbonate resin dissolved in the first solvent, and
a carbon black dispersion, comprising:
a second solvent; and
a carbon black dispersed in the second solvent.

6. The intermediate transferer of claim 1, wherein the intermediate transferer is a seamless belt.

7. An image forming apparatus, comprising:
an image bearer a latent image is formed on;
an image developer configured to develop the latent image with a toner to form a toner image on the image bearer;
the intermediate transferer according to claim 1, the toner image is first transferred onto; and
a transferer configured to transfer the toner image on the intermediate transferer onto a recording medium.

8. The image forming apparatus of claim 7, wherein the image forming apparatus is a full-color image forming apparatus comprising plural image bearers in series, each having an image developer for each color.
